(19) United States
(12) Patent Application Publication
(10) Pub. No.: US 2005/0039048 A1
(43) Pub. Date: Feb. 17, 2005

(54) Efficient new e-mail discovery

(75) Inventor: Joseph Peter Robert Tosey, N. Vancouver (CA)

Correspondence Address: Robert E. Krebs;THELEN REID & PRIEST LLP, P.O. BOX 640640, SAN JOSE, CA, 95164-0640, US

(73) Assignee: Sierra Wireless, Inc. a Canadian corp.

(21) Appl. No.: 10/638,254

(22) Filed: Aug. 7, 2003

(51) Int. Cl. H04L 9/00

(52) U.S. Cl. 713/201

(57) ABSTRACT

New e-mail may be identified in an efficient manner in order to speed polling times by utilizing the unique identifiers assigned to e-mails. A unique identifier for the most recently received mail for the mail client or the predicted value for such may be compared with the last unique identifier to be assigned by the mail server. If the identifiers are equal, then no new messages have been received and the mail client need not download any headers, which saves a significant amount of bandwidth. When the identifiers are not equal, the mail client need only download the new headers, which also saves bandwidth.

### FIELD OF THE INVENTION

The present invention relates to the field of electronic mail (e-mail). More particularly, the present invention relates to the efficient notification of new electronic mail arrival to electronic mail client by an electronic mail server.

### BACKGROUND OF THE INVENTION

Typical electronic mail (e-mail) systems utilize a mail server, often controlled by the Internet Service Provider (ISP) or other manager of email service, as well as a mail client located on each user's machine. The mail server typically has permanent access to the Internet, as well as other external networks and public data communications networks. The mail server stores and managers user electronic mails. Mail for each authorized user on the system is maintained within an individual storage architecture, commonly known as an inbox. FIG. 1 is a block diagram illustrating this type of design. A mail server 100 connected to a local area network (LAN) 102 may store incoming emails directed to the LAN, while another mail server 104 may operate as part of a public or private wide are network (WAN) 106. The mail server 100 may be periodically polled by desktop mail clients 108a, 108b, portable/handheld mail clients 110, and/or portable computer mail clients 112. A firewall 114 may be connected between the LAN 102 and the WAN 104. Desktop and laptop computers 116a, 116b may be connected to the WAN 104 via dial up 118 or dedicated 120 connections. Additionally, a desktop or laptop computer 122 and/or portable/handheld computing/communications device 124 may connect to the WAN 104 through a wireless connection 126a, 126b.

Mail received at the mail server is typically processed based on a recipient address identified within the electronic mail. Once the recipient is known, the mail server assigns a unique identifier to the piece of electronic mail, which is common in, for example, the IMAP4 standard. This identifier is unique among each mail user's inbox, such that each message in the inbox has a different identifier. These unique identifiers are typically assigned according to known algorithms. In this way, the mail server is able to provide electronic mail storage and management for a large population of authorized electronic mail clients.

Each user then may utilize a mail client to retrieve electronic mail from the mail server. The mail client can have only periodic access to the Internet, or other external networks and public data communications networks. The mail client may maintain local copies of selected electronic mails corresponding to the user. The mail client accesses the server to retrieve mail from the inbox. This is accomplished by providing authorization credentials to the authorized mail box. This may be repeated periodically to allow the mail client to download and/or copy newly received electronic mails into local storage. This is typically known as “polling”.

Typically, polling involves the mail client requesting a full listing of all the email header information. This full listing of all headers is then compared to the local storage record of the client. If there are any discrepancies, the client may then initiate data transfer(s) to synchronize the mail client's record with the mail server's record. This may include downloading new mail items that exist on the mail server but not on the mail client, as well as deleting old mail items that exist on the mail client but no longer exist on the mail server (for example, if an email has been recalled).

Each such polling event results in a large amount of data transferring between the mail server and the mail client. Furthermore, each polling event requires small but significant computational resources from the mail server. Frequent polling is required to ensure a short delay between the time when the mail server receives new mail and the time when the mail client is aware of the arrival of new mail. However, frequent polling increases the traffic capacity requirement of the network, as well as the computational resource usage on the mail server. On a wireless connection, bandwidth is of increased importance and thus this problem takes on even more relevance.

During the polling event, the mail client typically requests the header information for all messages on the server corresponding to that particular mail client. It then compares the unique identifiers of these downloaded headers to the messages stored on the mail client (i.e., the messages it previously downloaded). Any unique identifiers contained in the downloaded headers that are not stored on the mail client represent new messages. At this point, the mail client may also compare other header information, such as the status of the message, to determine if a previously downloaded message has been changed on the mail server side (for example, if it has been deleted because it was erroneously sent). The mail client may then request that the mail server send it the full messages corresponding to the unique identifiers it has concluded are “new”. This process is commonly known as synchronization.

Additionally, polling typically involves the client first establishing a Virtual Private Network (VPN) session with the mail server that is placed behind a corporate firewall. Establishment of a VPN session often requires the generation of encryption keys, exchange of encryption key data, initiation of data encryption services, exchange of authentication credentials, and initiation of session states. On RF based connections, it typically requires multiple distinct radio transmission access attempts or radio transmission slot requests/reservations/assignments by the portable client. Once the full listing of email header information has been downloaded, the client disconnects the VPN session. If the client determines there are any discrepancies between the header information and the local storage record (for example, new mail), it re-establishes the VPN session to the mail server, downloads the new mail or changed mail, deletes old mail, downloads another full listing of email headers to confirm the corrections, and disconnects thew VPN session.

What is needed is a solution that reduces the amount of bandwidth that is required to retrieve new e-mail from a mail server. What is further needed is a solution that reduces the amount of bandwidth used in re-establishing a VPN session upon each polling event.

### BRIEF DESCRIPTION OF THE INVENTION

New e-mail may be identified in an efficient manner in order to speed polling times by utilizing the unique identifiers assigned to e-mails. A unique identifier for the most recently received mail for the mail client or the predicted value for such may be compared with the last unique identifier to be assigned by the mail server. If the identifiers are equal, then no new messages have been received and the mail client need not download any headers, which saves a significant amount of bandwidth. When the identifiers are not equal, the mail client need only download the new headers, which also saves bandwidth.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a diagram illustrating a typical mail server and client system.

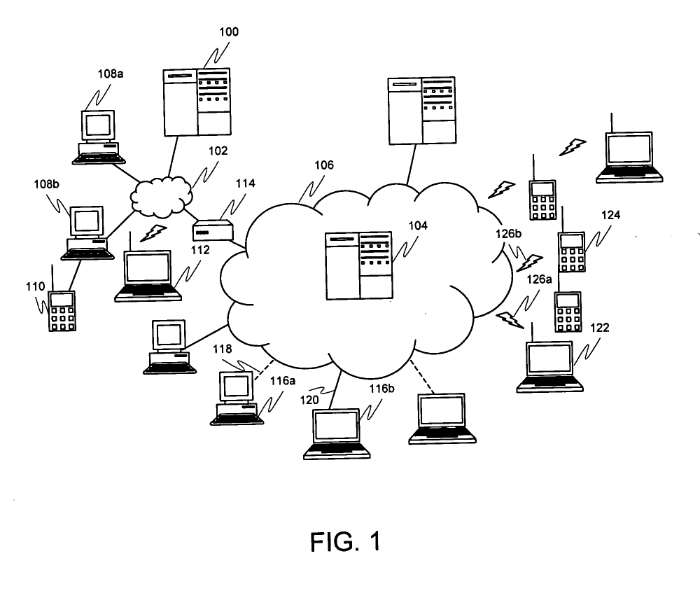

FIG. 2 is a diagram illustrating the unique identifier and its relationship between the mail server and mail client in accordance with an embodiment of the present invention.

FIG. 3 is a flow diagram illustrating a method for efficiently receiving notification of new e-mail from a mail server in accordance with an embodiment of the present invention.

FIG. 4 is a flow diagram illustrating a method for efficiently receiving notification of new e-mail from a mail server in accordance with another embodiment of the present invention.

FIG. 5 is a block diagram illustrating a method for efficiently receiving notification of new e-mail from a mail server in accordance with an embodiment of the present invention.

FIG. 6 is a block diagram illustrating an apparatus for efficiently receiving notification of new e-mail from a mail server in accordance with another embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention provides a solution that allows for new e-mail to be identified in an efficient manner in order to speed polling times. A unique identifier for the most recently received mail for the mail client may be compared with the last unique identifier to be assigned by the mail server. If the identifiers are equal, then no new messages have been received and the mail client need not download any headers, which saves a significant amount of bandwidth. When the identifiers are not equal, the mail client need only download the new headers, which also saves bandwidth.

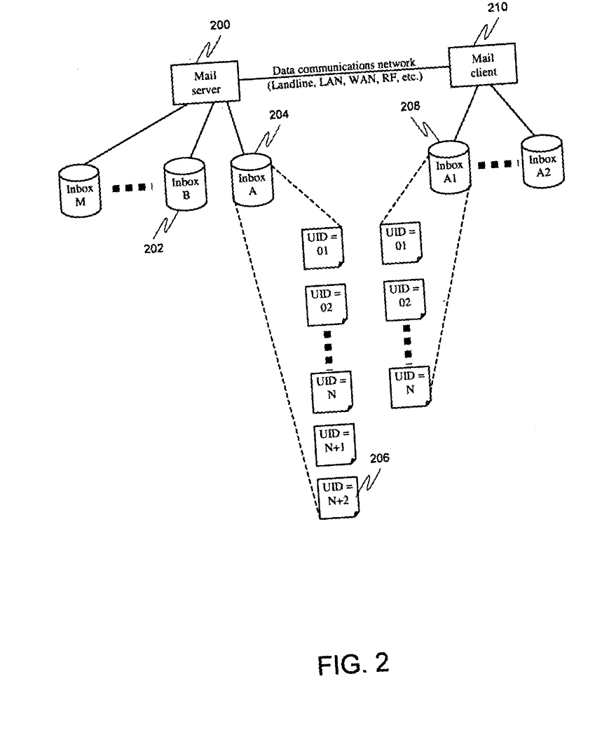

FIG. 2 is a diagram illustrating the unique identifier and its relationship between the mail server and mail client in accordance with an embodiment of the present invention. The mail server 200 may manage a plurality of mailboxes 202, 204 serving a plurality of mail clients. Each mailbox 204 may contain one or more mail records 206. Each record 206 may be associated with an identifier. Each identifier may be assigned by the mail server and be guaranteed to be unique within the mailbox. In this example, mailbox 204 contains N+2 mail records uniquely identified with UID values from 1 to N+2. In this example, inbox A may be associated with mailbox 208 on the illustrated mail client 210.

In most circumstances, e-mail users are mainly interested in the arrival of new e-mails. While old e-mails can have their status' changed (such as if a mail server is instructed to recall an erroneously sent e-mail), such cases are rare without the user's awareness. Additionally, unmodified old e-mails within the user's inbox on the mail server are of little interest to the user. These items would have been previously downloaded, and presumably stored on the mail client.

With this in mind, in an embodiment of the present invention, the mail client may note the unique identifier associated with the most recently received mail item within its local storage. It then may initiate a query to the mail server to request to determine the unique identifier associated with the most recently received mail item within the server's in-box. In an embodiment of the present invention, this may be accomplished by simply sending a request for the status of the unique identifier to the server. The server may then simply locate the most recently received mail item and examine its unique identifier. However, in cases where the algorithm used to assign unique identifiers to new mail is known, the determination of the unique identifier associated with the most recently received mail within the mail server's inbox may be inferred from responses that do not directly contain the unique identifier. In this embodiment, the mail client may request the value of the next UID to be assigned, and once it is received, modify it according to the algorithm. For example, in the conventional IMAP4 protocol, a 32-bit unique identifier is simply incremented by one for each new email received for the mail user. In such a case, a return value indicating the unique identifier value to be assigned next can be used to predict the value of the last unique identifier value to be assigned. In this example, that would be accomplished by subtracting one from the value of the next unique identifier value to be assigned. This is merely one example, however, and one of ordinary skill in the art will recognize that any type of algorithm may be used.

If the local value of the unique identifier associated with the most recently received mail item on the mail client is identical to the value of the last unique identifier assigned by the mail server corresponding to the mail client, then there have not been any new e-mails received. The mail client then does not need to proceed any further.

If the local value of the unique identifier associated with the most recently received mail item on the mail client differs from the value of the last unique identifier assigned by the mail server corresponding to the mail client, then the mail server has received new e-mail. In this case, the mail client may then proceed to retrieve the new e-mail, or proceed with other actions as appropriate.

In an embodiment of the present invention, the query for the unique identifier is a short command and may be concatenated with the necessary mail command session open and close commands. The concatenated set of commands is still short and can better fit within a single data communications packet. This reduces data communications access overhead and reduces delivery latency. The unique identifier query response is short since there is no requirement to attach unnecessary message header information. This reduces the processing load on the e-mail server and minimizes data communications traffic.

Furthermore, as described above, in typical mail client implementations, a new virtual private network (VPN) session is established and torn down for each mail server poll. In an embodiment of the present invention, a single VPN session may be maintained for an indefinite period of time, thus eliminating the need to tear down and re-establish the VPN session between polling events. In an embodiment of the present invention, this may be accomplished by sending a short No-Operation (NOOP) command to the server periodically to keep the VPN session active. In another embodiment of the present invention, the reduced bandwidth taken to check for new mail accomplished by the solution described above allows the client to set the polling rate at a much higher rate than typical. In this embodiment, the polling rate may be sufficiently high to keep the VPN session active without the need for a NOOP command.

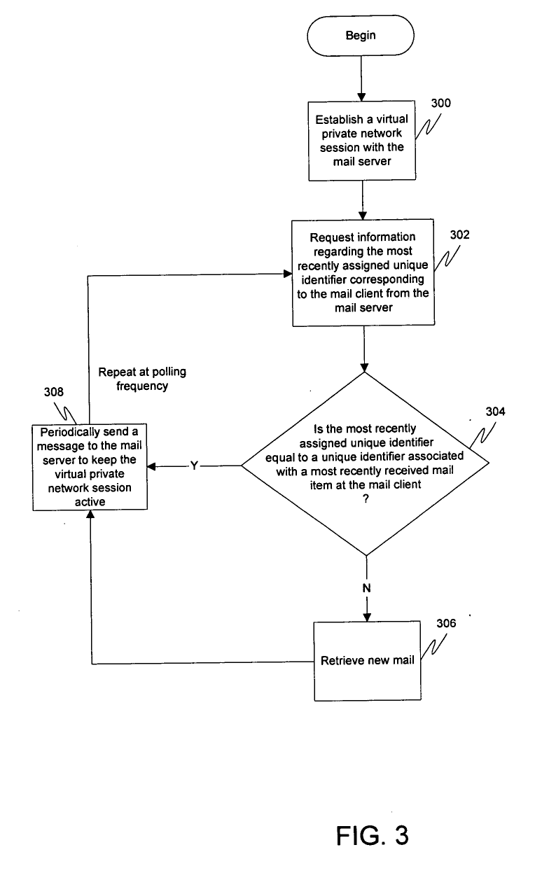

FIG. 3 is a flow diagram illustrating a method for efficiently receiving notification of new e-mail from a mail server in accordance with an embodiment of the present invention. This method may be executed in whole or in part at a mail client. At 300, a virtual private network (VPN) session may be established with the mail server. At 302, information regarding the most recently assigned unique identifier corresponding to the mail client may be requested from the mail server. This may include requesting a status of a unique identifier from the mail server. This may also include concatenating the request with mail command session open and close commands to fit, for example, within a single communications packet. At 304, the most recently assigned unique identifier may be compared to a unique identifier associated with a most recently received mail item at the mail client. At 306, new mail may be retrieved for the mail client from the mail server if the most recently assigned unique identifier is not equal to the unique identifier associated with the most recently received mail item. At 308, a message may be periodically sent to the mail server to keep the VPN session active. Alternatively, the polling frequency may simply be set high enough to keep the VPN session active. The requesting, comparing, and retrieving act as a poll, and also may act to keep the VPN session alive. Setting the polling frequency higher than in traditional mail client environments may be permitted because with the present invention, each poll takes less bandwidth.

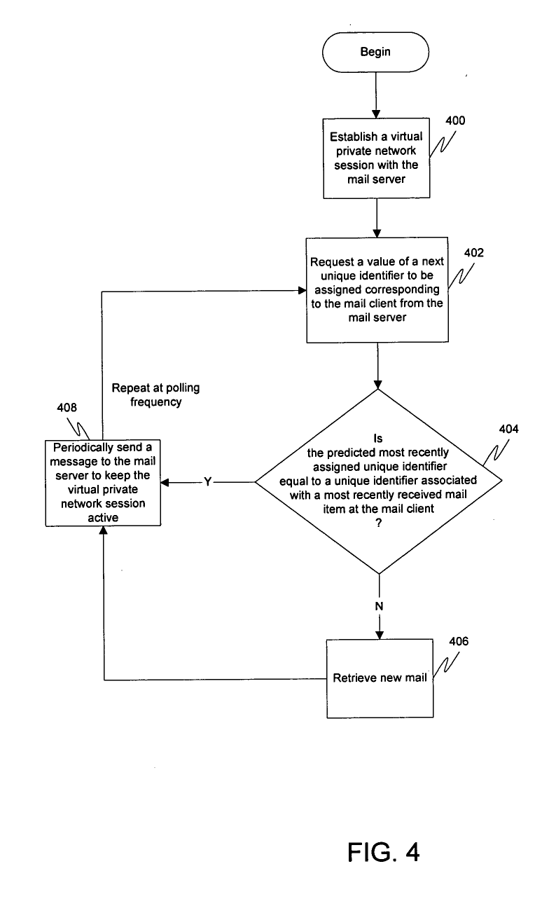

FIG. 4 is a flow diagram illustrating a method for efficiently receiving notification of new e-mail from a mail server in accordance with another embodiment of the present invention. This method may be executed in whole or in part at a mail client. At 400, a virtual private network (VPN) session may be established with the mail server. At 402, a value of a next unique identifier to be assigned corresponding to the mail client may be requested from the mail server. This may include concatenating the request with mail command session open and close commands to fit, for example, within a single communications packet. At 404, a predicted most recently assigned unique identifier may be compared to a unique identifier associated with a most recently received mail item at the mail client, wherein the predicted most recently assigned unique identifier may be based on the value. The predicted most recently assigned unique identifier may be determined by applying the reverse of a known unique identifier assignment algorithm to the value. At 406, new mail may be retrieved for the mail client from the mail server if the predicted most recently assigned unique identifier is not equal to the unique identifier associated with the most recently received mail item. At 408, a message may be periodically sent to the mail server to keep the VPN session active. Alternatively, the polling frequency may simply be set high enough to keep the VPN session active. The requesting, comparing, and retrieving act as a poll, and also may act to keep the VPN session alive. Setting the polling frequency higher than in traditional mail client environments may be permitted because with the present invention, each poll takes less bandwidth.

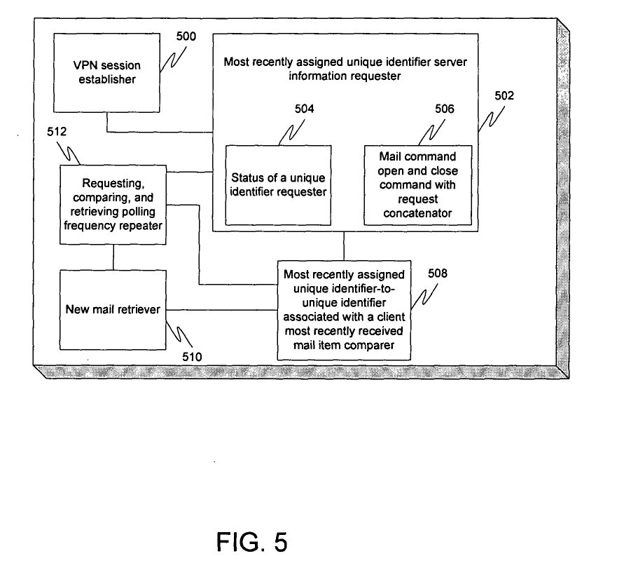

FIG. 5 is a block diagram illustrating a method for efficiently receiving notification of new e-mail from a mail server in accordance with an embodiment of the present invention. This may be located in whole or in part at a mail client. A VPN session establisher 500 may establish a virtual private network (VPN) session with the mail server. A most recently assigned unique identifier server information requester 502 coupled to the VPN session establisher 500 may request information regarding the most recently assigned unique identifier corresponding to the mail client from the mail server. This may include requesting a status of a unique identifier from the mail server using a status of a unique identifier requester 504. This may also include concatenating the request with mail command session open and close commands to fit, for example, within a single communications packet using a mail command session open and close command with request concatenator 506. A most recently assigned unique identifier-to-unique identifier associated with a client most recently received mail item comparer 508 coupled to the most recently assigned unique identifier server information requester 502 may compare the most recently assigned unique identifier to a unique identifier associated with a most recently received mail item at the mail client. A new mail receiver 510 coupled to the most recently assigned unique identifier-to-unique identifier associated with a client most recently received mail item comparer 508 may retrieve new mail for the mail client from the mail server if the most recently assigned unique identifier is not equal to the unique identifier associated with the most recently received mail item. A message may be periodically sent to the mail server to keep the VPN session active. Alternatively, the polling frequency may simply be set high enough to keep the VPN session active. The requesting, comparing, and retrieving act as a poll using a requesting, comparing, and retrieving polling frequency repeater 512 coupled to the server next unique identifier to be assigned value requester, the server next unique identifier to be assigned-to-unique identifier associated with a client most recently received mail item comparer, and the new mail retriever also may act to keep the VPN session alive. Setting the polling frequency higher than in traditional mail client environments may be permitted because with the present invention, each poll takes less bandwidth.

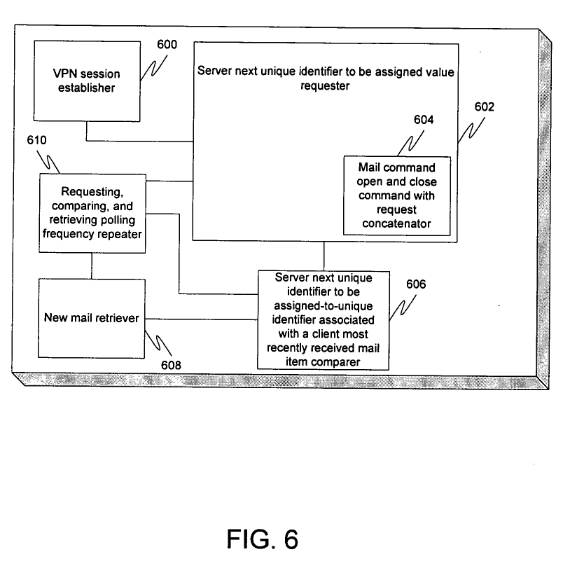

FIG. 6 is a block diagram illustrating an apparatus for efficiently receiving notification of new e-mail from a mail server in accordance with another embodiment of the present invention. This may be located in whole or in part at a mail client. A VPN session establisher 600 may establish a virtual private network (VPN) session with the mail server. A server next unique identifier to be assigned value requester 602 coupled to the VPN session establisher 600 may request a value of a next unique identifier to be assigned corresponding to the mail client from the mail server. This may include concatenating the request with mail command session open and close commands to fit, for example, within a single communications packet using a mail command session open and close command with request concatenator 604. A server next unique identifier to be assigned-to-unique identifier associated with a client most recently received mail item comparer 606 coupled to the server next unique identifier to be assigned value requester 602 may compare a predicted most recently assigned unique identifier to a unique identifier associated with a most recently received mail item at the mail client, wherein the predicted most recently assigned unique identifier may be based on the value. The predicted most recently assigned unique identifier may be determined by applying the reverse of a known unique identifier assignment algorithm to the value. A new mail retriever 608 coupled to the server next unique identifier to be assigned-to-unique identifier associated with a client most recently received mail item comparer 606 may retrieve new mail for the mail client from the mail server if the predicted most recently assigned unique identifier is not equal to the unique identifier associated with the most recently received mail item. A message may be periodically sent to the mail server to keep the VPN session active. Alternatively, the polling frequency may simply be set high enough to keep the VPN session active. The requesting, comparing, and retrieving act as a poll using a requesting, comparing, and retrieving polling frequency repeater 610 coupled to the server next unique identifier to be assigned value requester 602, the server next unique identifier to be assigned-to-unique identifier associated with a client most recently received mail item comparer 606, and the new mail retriever 608 also may act to keep the VPN session alive. Setting the polling frequency higher than in traditional mail client environments may be permitted because with the present invention, each poll takes less bandwidth.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method for efficiently receiving notification of new e-mail from a mail server, the method comprising:
requesting information regarding a most recently assigned unique identifier corresponding to a mail client from said mail server;
comparing said most recently assigned unique identifier to a unique identifier associated with a most recently received mail item at said mail client; and
retrieving new mail for said mail client from the mail server if said most recently assigned unique identifier is not equal to said unique identifier associated with said most recently received mail item.

2. The method of claim 1, wherein said requesting includes requesting a status of a unique identifier from said mail server.

3. The method of claim 1, further comprising establishing a virtual private network (VPN) session with said mail server before said requesting.

4. The method of claim 3, further comprising periodically sending a message to said mail server to keep said VPN session active.

5. The method of claim 3, further comprising repeating said requesting, comparing, and retrieving at a rate equal to a polling frequency.

6. The method of claim 5, wherein said polling frequency is set high enough such that said VPN session remains active in response to said requesting, comparing, and retrieving.

7. The method of claim 1, wherein said requesting includes concatenating said request with mail command session open and close commands.

8. The method of claim 7, wherein said concatenated request fits within a single communications packet.

9. A method for efficiently receiving notification of new e-mail from a mail server, the method comprising:
requesting a value of a next unique identifier to be assigned corresponding to a mail client from said mail server;
comparing a predicted most recently assigned unique identifier to a unique identifier associated with a most recently received mail item at said mail client, wherein said predicted most recently assigned unique identifier is based on said value; and
retrieving new mail for said mail client from the mail server if said predicted most recently assigned unique identifier is not equal to said unique identifier associated with said most recently received mail item.

10. The method of claim 9, wherein said predicted most recently assigned unique identifier is determined by a applying the reverse of a known unique identifier assignment algorithm to said value.

11. The method of claim 9, further comprising establishing a virtual private network (VPN) session with said mail server before said requesting.

12. The method of claim 11, further comprising periodically sending a message to said mail server to keep said VPN session active.

13. The method of claim 11, further comprising repeating said requesting, comparing, and retrieving at a rate equal to a polling frequency.

14. The method of claim 13, wherein said polling frequency is set high enough such that said VPN session remains active in response to said requesting, comparing, and retrieving.

15. The method of claim 9, wherein said requesting includes concatenating said request with mail command session open and close commands.

16. The method of claim 15, wherein said concatenated request fits within a single communications packet.

17. An apparatus for efficiently receiving notification of new e-mail from a mail server, the apparatus comprising:
a most recently assigned unique identifier server information requester;
a most recently assigned unique identifier-to-unique identifier associated with a client most recently received mail item comparer coupled to said most recently assigned unique identifier server information requester; and
a new mail retriever coupled to said most recently assigned unique identifier-to-unique identifier associated with a client most recently received mail item comparer.

18. The apparatus of claim 17, wherein said most recently assigned unique identifier server information requester includes a status of a unique identifier requester.

19. The apparatus of claim 17, further comprising:
a virtual private network (VPN) session establisher coupled to said most recently assigned unique identifier server information requester.

20. The apparatus of claim 17, further comprising:
a requesting, comparing, and retrieving polling frequency repeater coupled to said most recently assigned unique identifier server information requester, said most recently assigned unique identifier-to-unique identifier associated with a client most recently received mail item comparer, and said new mail retriever.

21. The apparatus of claim 17, wherein said most recently assigned unique identifier server information requester includes a mail command session open and close command with request concatenator.

22. An apparatus for efficiently receiving notification of new e-mail from a mail server, the apparatus comprising:
a server next unique identifier to be assigned value requester;
a server next unique identifier to be assigned-to-unique identifier associated with a client most recently received mail item comparer coupled to said server next unique identifier to be assigned value requester; and
a new mail retriever coupled to said server next unique identifier to be assigned-to-unique identifier associated with a client most recently received mail item comparer.

23. The apparatus of claim 22, further comprising:
a virtual private network (VPN) session establisher coupled to said server next unique identifier to be assigned value requester.

24. The apparatus of claim 22, further comprising:
a requesting, comparing, and retrieving polling frequency repeater coupled to said server next unique identifier to be assigned value requester, said server next unique identifier to be assigned-to-unique identifier associated with a client most recently received mail item comparer, and said new mail retriever.

25. The apparatus of claim 22, wherein said server next unique identifier to be assigned value requester includes a mail command session open and close command with request concatenator.

26. An apparatus for efficiently receiving notification of new e-mail from a mail server, the apparatus comprising:
means for requesting information regarding a most recently assigned unique identifier corresponding to a mail client from said mail server;
means for comparing said most recently assigned unique identifier to a unique identifier associated with a most recently received mail item at said mail client; and
means for retrieving new mail for said mail client from the mail server if said most recently assigned unique identifier is not equal to said unique identifier associated with said most recently received mail item.

27. The apparatus of claim 26, wherein said means for requesting includes means for requesting a status of a unique identifier from said mail server.

28. The apparatus of claim 26, further comprising means for establishing a virtual private network (VPN) session with said mail server before said requesting.

29. The apparatus of claim 28, further comprising means for periodically sending a message to said mail server to keep said VPN session active.

30. The apparatus of claim 28, further comprising means for repeating said requesting, comparing, and retrieving at a rate equal to a polling frequency.

31. The apparatus of claim 30, wherein said polling frequency is set high enough such that said VPN session remains active in response to said requesting, comparing, and retrieving.

32. The apparatus of claim 26, wherein said means for requesting includes means for concatenating said request with mail command session open and close commands.

33. The apparatus of claim 32, wherein said concatenated request fits within a single communications packet.

34. An apparatus for efficiently receiving notification of new e-mail from a mail server, the apparatus comprising:
means for requesting a value of a next unique identifier to be assigned corresponding to a mail client from said mail server;
means for comparing a predicted most recently assigned unique identifier to a unique identifier associated with a most recently received mail item at said mail client, wherein said predicted most recently assigned unique identifier is based on said value; and
means for retrieving new mail for said mail client from the mail server if said predicted most recently assigned unique identifier is not equal to said unique identifier associated with said most recently received mail item.

35. The apparatus of claim 34, wherein said predicted most recently assigned unique identifier is determined by a applying the reverse of a known unique identifier assignment algorithm to said value.

36. The apparatus of claim 34, further comprising means for establishing a virtual private network (VPN) session with said mail server before said requesting.

37. The apparatus of claim 36, further comprising means for periodically sending a message to said mail server to keep said VPN session active.

38. The apparatus of claim 36, further comprising means for repeating said requesting, comparing, and retrieving at a rate equal to a polling frequency.

39. The apparatus of claim 38, wherein said polling frequency is set high enough such that said VPN session remains active in response to said requesting, comparing, and retrieving.

40. The apparatus of claim 34, wherein said means for requesting includes means for concatenating said request with mail command session open and close commands.

41. The apparatus of claim 40, wherein said concatenated request fits within a single communications packet.

42. A program storage device readable by a machine, tangibly embodying a program of instructions executable by the machine to perform a method for efficiently receiving notification of new e-mail from a mail server, the method comprising:
requesting information regarding a most recently assigned unique identifier corresponding to a mail client from said mail server;
comparing said most recently assigned unique identifier to a unique identifier associated with a most recently received mail item at said mail client; and
retrieving new mail for said mail client from the mail server if said most recently assigned unique identifier is not equal to said unique identifier associated with said most recently received mail item.

43. A program storage device readable by a machine, tangibly embodying a program of instructions executable by the machine to perform a method for efficiently receiving notification of new e-mail from a mail server, the method comprising:
requesting a value of a next unique identifier to be assigned corresponding to a mail client from said mail server;
comparing a predicted most recently assigned unique identifier to a unique identifier associated with a most recently received mail item at said mail client, wherein said predicted most recently assigned unique identifier is based on said value; and
retrieving new mail for said mail client from the mail server if said predicted most recently assigned unique identifier is not equal to said unique identifier associated with said most recently received mail item.
